(19) United States
(12) Patent Application Publication
(10) Pub. No.: US 2014/0312997 A1
(43) Pub. Date: Oct. 23, 2014

(54) Encapsulated Reed Relay

(71) Applicant: Pickering Electronics Limited, Clacton-on-Sea (GB)

(72) Inventor: Graham Dale, Colchester (GB)

(73) Assignee: Pickering Electronics Limited, Clacton-on-Sea (GB)

(21) Appl. No.: 14/222,007

(22) Filed: Mar. 21, 2014

(30) Foreign Application Priority Data
Mar. 22, 2013 (GB) 1305260.0

(51) Int. Cl. H01H 49/00; H01H 51/29

(52) U.S. Cl. CPC H01H 49/00; H01H 51/29
USPC 335/202; 29/622

(57) ABSTRACT

A method of manufacturing a surface-mount encapsulated reed relay comprises providing metal lead-frame having conductors for connecting the relay to a circuit and insert-moulding a plastics material plate to the lead-frame so that the conductors extend through the plate and are bonded thereto. Unwanted lead-frame parts are cut away on at least one side of the plate, leaving the conductors exposed for the connection thereto of a reed relay capsule and operating coil, whereafter a housing is fitted to the plate so as to embrace the reed relay capsule and operating coil. A soft elastomeric material is injected into a space defined by the plate and the housing to encapsulate the relay capsule and the operating coil, and then any remaining unwanted lead-frame parts are cut away such that the conductors are exposed on the other side of the plate, to allow those exposed conductors to be formed to lie in a common plane substantially parallel to or co-planar with a face of the encapsulated reed relay which face will in use lie against a circuit board. In an alternative method, two plates are insert-moulded to the lead-frame in a spaced-apart disposition, a U-shaped housing co-operating with the plates to form an enclosure for the relay capsule and coil.

### CROSS REFERENCE TO RELATED APPLICATIONS

This application claims the priority of UK Patent Application No. 1305260.0 filed in the name of Pickering Electronics Limited on Mar. 22, 2013.

a) Field of the Invention

This invention relates to a method of manufacturing an encapsulated reed relay, intended for use as a surface-mount device (SMD) on circuit boards. The invention also relates to an encapsulated reed relay per se.

b) Description of the Prior Art

A typical reed relay comprises a tubular glass envelope within which are mounted reed contacts which are normally open but can be configured so as to be normally closed, and a coil surrounding the envelope. It is also possible to provide three contacts within the envelope, arranged as a change-over switch. When the coil is energised, the contacts change their state, so as then to be open or closed, respectively, or in the case of a change-over relay, the common contact moves from the normally closed contact to the normally open contact. The contacts return to their original state when the coil is de-energised. The glass envelope together with its internal contacts and pins (but sometimes wires) leading away from the envelope is usually referred to as a capsule.

Modern circuit design may require high density packing of reed relays on a circuit board. A typical relay comprises a housing having an open face and containing the reed relay capsule together with a surrounding coil. After positioning the capsule and coil within the housing and providing connection pins soldered to the capsule and coil, the surrounding space is filled with a suitable potting compound, with the connecting pins for the capsule and coil projecting from the open face of the housing. In use, the pins extend into holes in a printed circuit board (PCB) and are soldered to tracks (conductors) on the board.

The potting compound may be a thermo-setting resin sufficiently strong securely to hold the reed relay capsule in the housing and positively restrain the pins in position. However a disadvantage of using a relatively hard thermo-setting resin is that the sensitive relay capsule is not isolated from physical shock, vibrations and so on, or protected against the various expansion characteristics of the materials used in the construction of the relay. In an attempt to address this, it is known to use an elastomeric potting compound such as a soft silicon-rubber material, a polyurethane or the like.

With multi-layer PCBs, ever more electronic components are being manufactured as surface-mount devices such that no pins or wires from the components have to extend through holes in the board; rather, the connecting pins or wires are soldered to tracks on the same face of the board as carries the component. In the case of an encapsulated reed relay, it has proved to be difficult to provide the connecting pins in a common plane without straining the pins and the connections internally of the device to the reed relay capsule and coil. If an elastomeric potting compound is used, bending of the pins to lie in a common plane so that the relay may serve as an SMD puts undue strain on the connections within the housing of the pins to the capsule and coil and early failure can be expected.

### BRIEF SUMMARY OF THE INVENTION

This invention attempts to address the above problem, of providing a manufacturing method for the manufacture of an encapsulated reed relay suitable for use as an SMD, and without placing significant strain on the internal connections within the housing of the relay, as well as such a reed relay per se.

According to the broadest aspect of this invention, there is provided a method of manufacturing a surface-mount encapsulated reed relay, comprising the steps of:
providing at least one metal lead-frame including conductors required for connecting the relay to a circuit, the conductors of the at least one lead-frame being mechanically interconnected by lead-frame parts;
insert-moulding a plastics material plate to the at least one lead-frame so that the relay conductors extend through the plate and are bonded thereto;
cutting away any unwanted lead-frame parts on at least one side of the plate, leaving the relay conductors exposed on said one side of the plate;
connecting a reed relay capsule and operating coil to the respective conductors on said one side of the plate;
fitting a housing to the plate so as to embrace the reed relay capsule and operating coil;

and then in either order:
injecting a soft elastomeric material into a space defined by the plate and the housing to encapsulate the relay capsule and the operating coil; and
cutting away any remaining unwanted lead-frame parts such that the relay conductors are exposed on the other side of the plate;

and thereafter:
forming the exposed conductors projecting from the other side of the plate to lie in a common plane substantially parallel to or co-planar with a face of the encapsulated reed relay which face will in use lie against a circuit board.

This invention extends to a surface-mount encapsulated reed relay whenever manufactured by a method of this invention.

Further, and according to a closely related aspect of this invention, there is provided a surface-mount encapsulated reed relay comprising:
an insert-moulded plastics material plate having relay conductors extending therethrough and bonded to the plate;
a reed relay capsule and surrounding coil connected to the respective conductors on one side of the plate;
a housing fitted to said one side of the plate so as to overlie the reed relay capsule and surrounding coil; and
a soft elastomeric material disposed within a space defined by the plate and housing to encapsulate the relay capsule and the coil;

wherein the conductors projecting from the other side of the plate opposed to the capsule and coil are formed to lie in a common plane substantially parallel to or co-planar with a face of the encapsulated reed relay.

### BRIEF DESCRIPTION OF THE SEVERAL VIEWS OF THE DRAWINGS

The drawings show specific embodiments of a reed relay manufactured by methods of this invention, though solely by way of example. In the drawings:

FIG. 1 is an exploded view of a first example of an encapsulated SMD reed relay in the course of manufacture by a method of this invention;

FIG. 2 shows the insert-moulding of the base plate, to include a pair of lead-frames disposed one at each end of the base plate;

FIG. 3 is an exploded view of a second example of an encapsulated SMD reed relay in the course of manufacture by a second method of this invention;

FIG. 4 shows the finished SMD reed relay manufactured as shown in FIG. 2;

FIGS. 5 and 6 show in more detail the manufacturing process for the relay of FIGS. 3 and 4;

FIG. 7 is a plan view on the assembly of FIG. 5;

FIG. 8 is a detail view on an enlarged scale of the area ringed on FIG. 7 and identified with the letter B;

FIG. 9 is an isometric view of another example of an SMD reed relay manufactured by a method according to this invention and including an internal magnetic shield, before potting; and

FIG. 10 is a further view of the relay of FIG. 9, again before potting.

### DETAILED DESCRIPTION OF THE INVENTION

With the method of this invention, the conductors for connecting the relay capsule and coil to an external circuit extend through a moulded plastics material plate which integrates with the housing when the relay is potted. External bending of the pins will not therefore be transferred to the interior of the housing and the delicate connections between the pins within the housing and the relay capsule and coil will be isolated from any such bending. Thus, following manufacture of the encapsulated reed relay, the pins may be bent to a suitable profile substantially co-planar with or parallel to a face of the housing so that the relay may be used as an SMD.

In performing the method of the invention, the cutting away of any unwanted lead-frame parts on the side of the plate against which the relay capsule and coil lie, or between the two plates for an alternative method, may not be necessary, depending on the configuration of the lead-frame prior to the insert-moulding step. For example, the lead-frame could have a supporting end portion from which a plurality of pins extend, the ends of the pins remote from the supporting end portion being free and pre-configured for the connection of the relay capsule and coil; in this case, there would be no unwanted lead-frame parts to cut away following the insert-moulding step. Conversely, the lead-frame could have two supporting end portions with a plurality of pins extending therebetween; in this case, there would be unwanted parts of the lead-frame which must be cut away before the relay capsule and coil can be connected to the pins. Thus, the step of cutting away any unwanted lead-frame parts is performed only if there are such parts which need to be cut away to allow the assembly of the relay capsule and coil to the pins of the lead-frame.

The insert-moulded plastics material plate may comprise a base plate for the encapsulated relay with the conductors for the relay extending through that plate. In the alternative, two plastics material plates may be insert-moulded to the conductors so as to be bonded thereto, the two plates being moulded in a spaced-apart disposition whereby the reed relay capsule and operating coil are subsequently disposed between the two plates. Though the two plates may be entirely separate, it may be preferred to link together the two plates for example by means of one or more rails extending therebetween and moulded integrally therewith, or even by a continuous wall extending between the plates and moulded integrally therewith. In either case, the conductors preferably extend through the plate or plates at substantially 90° to the plane thereof but may be bent through a required angle on one or both sides of the plate or plates, to give the required connectivity both for the capsule and coil and also for connection to a PCB.

In a preferred method, there is provided a single lead-frame which has all of the required conductors connected together by lead-frame parts, such that on subsequent cutting away of the lead-frame parts, the conductors are left extending through the plate or plates, electrically isolated from the others. The lead-frame parts may be cut away in stages; for example, in the case of the provision of a pair of lead-frames, salvage strips may be cut from those frames on one side of the plate at an early stage in the manufacturing process, and then any remaining salvage strips may be cut from those frames following the potting of the components within the housing.

The housing may comprise a magnetic shield, for example of mu-metal, fitted to the plate or plates, so as partially to enclose the relay capsule and coil. In the alternative, the housing may comprise a rigid plastics material case fitted to the plate or plates but in this case a separate magnetic shield, for example of mu-metal may be provided within the housing, so as partially to enclose the relay capsule and coil.

Rather than having a single moulded plastics material plate, a pair of spaced-apart substantially parallel insert-moulded plastics material plates may be provided, each plate having relay conductors extending therethrough and bonded to the plate. As mentioned above, the plates may be moulded integrally with one or more rails or walls extending therebetween. A reed relay capsule and a surrounding coil may be connected to the respective conductors between the two plates. This arrangement allows the use of a single lead-frame defining all of the required conductors held together by lead-frame parts which are cut away at the completion of the manufacturing process.

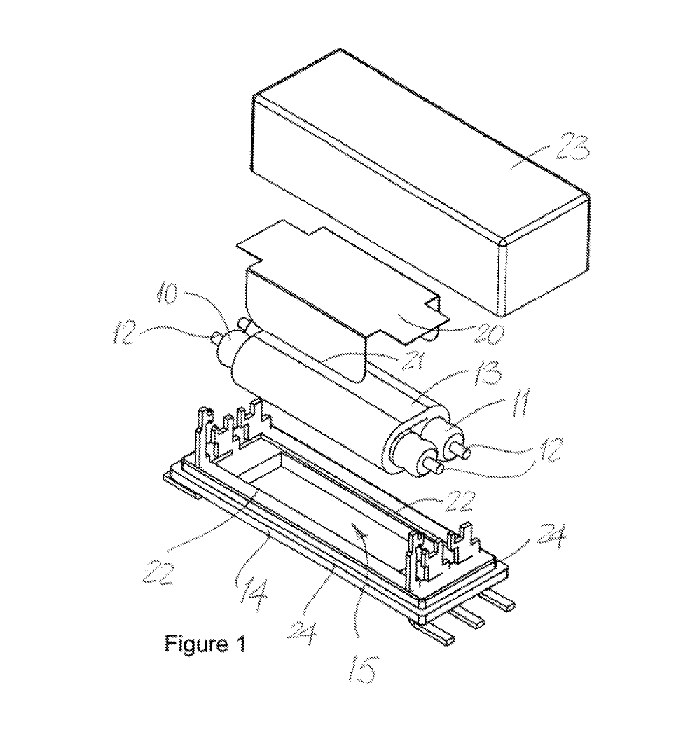

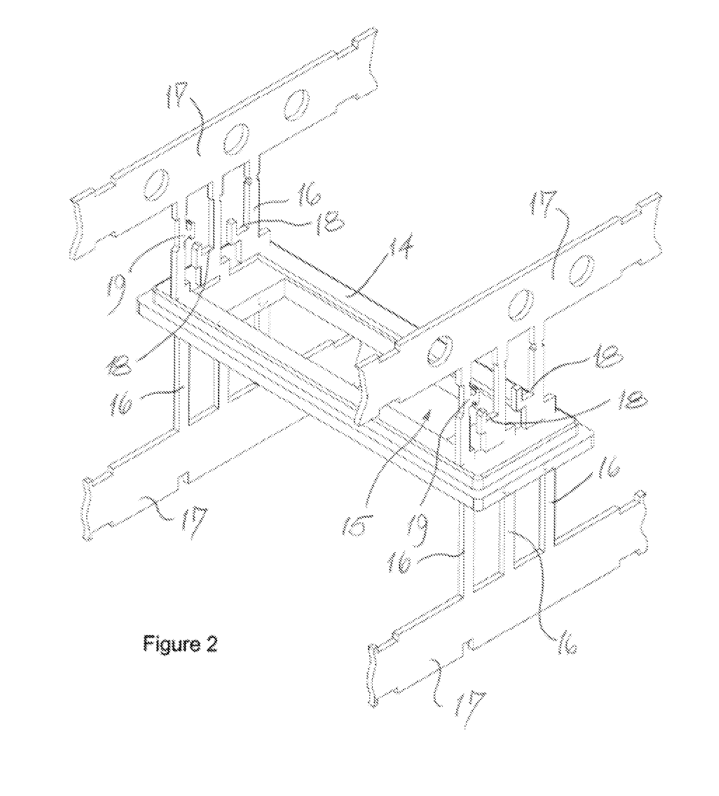

Referring now to the drawings, and specifically to FIGS. 1 and 2, there are shown the principal components for the manufacture of an encapsulated SMD reed relay having two pairs of contacts in separate capsules. Two glass capsules 10,11 are arranged side-by-side with respective contacts (not shown) in the capsules, and with pins 12 extending axially out of the capsules by a relatively short distance. A single coil 13 is provided around the capsules and has connecting wires (not shown) leading away from the coil for connection to pins of the device, as will be described below.

A base plate 14 for the relay is moulded from a plastics material and is substantially planar but with an opening 15 formed therethrough. The base plate 14 is moulded together with two separate lead-frames (FIG. 2) each of which provides three pre-formed metal pins 16, by an insert-moulding operation such that the pins extend through the base plate and are bonded thereto. Such insert-moulding techniques are well known in the plastics moulding art; briefly, the mould for the base plate is arranged to carry the lead-frames in suitable positions whereafter the plastics material is injected into the mould so as to surround and bond to the pins 16 of the lead-frames and form an integral unit therewith. Following the moulding step, the end portions 17 of the lead-frames on at least one side of the base plate (and in FIG. 2, the upper side of the base plate) are cut away to leave the pins 16 extending through the base plate. In view of this, any bending of a part of a pin on one side of the base plate 14 will not affect the part of the same pin on the other side of the base plate. By leaving the end portions 17 of the lead-frames below the base plate in place, this imparts stability to the pins until the relay is substantially finished, at which point the remaining end portions may be cut away.

As moulded, two of the pins 16 at each end of the plate 14 include an internal part 18 which is forked to receive a respective pin 12 projecting from a capsule 10 or 11. The internal parts 18 are appropriately configured to hold the capsule pins 12 without placing any strain on the capsules. An electrical connection may be made between the pins by way of a soldering operation, a welding operation, a laser welding operation or other suitable techniques. A further pin 16 (one at each end) includes an internal part 19 which upstands higher than the internal parts 18, the two ends of the coil 13 being soldered or otherwise electrically connected to the upper ends of the internal parts 19.

A mu-metal shield 20, serving as a magnetic shield and of U-shaped form, is fitted over the capsules 10,11 and coil 13 with the free edges 21 of the shield fitting into a groove 22 formed in the upper face of the base plate 14. Then, a five-sided generally rectangular hard plastics material outer case 23 is fitted over the shield and the internal parts 18,19 of the pins 16. The outer case 23 locates on an upstanding lip 24 formed around the periphery of the base plate 14. Finally, a soft elastomeric potting compound, such as of silicon-rubber, is injected through the opening 15 in the base plate 14 to encapsulate all of the components within the outer case 23.

Following completion of the reed relay as has been described above, and the cutting away of the remaining end portions 17 if still attached to the external parts of the pins 16 leading away from the base plate 14, those parts of the pins are bent as may be required all to lie in a common plane substantially parallel to the lower face of the base plate 14. With the pins co-planar in this way, the reed relay is suitable for use as an SMD on a PCB.

The reed relay manufacturing method described above may employ usual techniques and materials as is common with the manufacture of conventional reed relays. For example, the pins may be manufactured from a Ni—Fe alloy plated with gold or tin. A high melting point solder may be used for connecting the capsule pins 12 to the internal parts 18 of the pins 16 and also to connect the coil wires to the internal parts 19 of those pins, so that those solder connections will not melt on soldering the device as a whole to a PCB. The base plate 14 may be moulded from a hard resin such as a thermo-setting material with a high melting point, as may be the outer case.

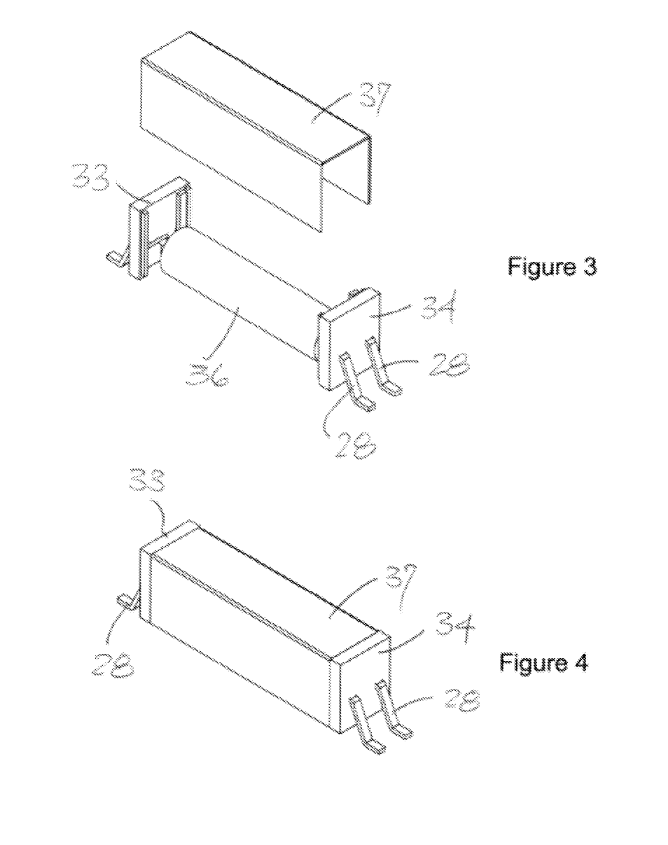

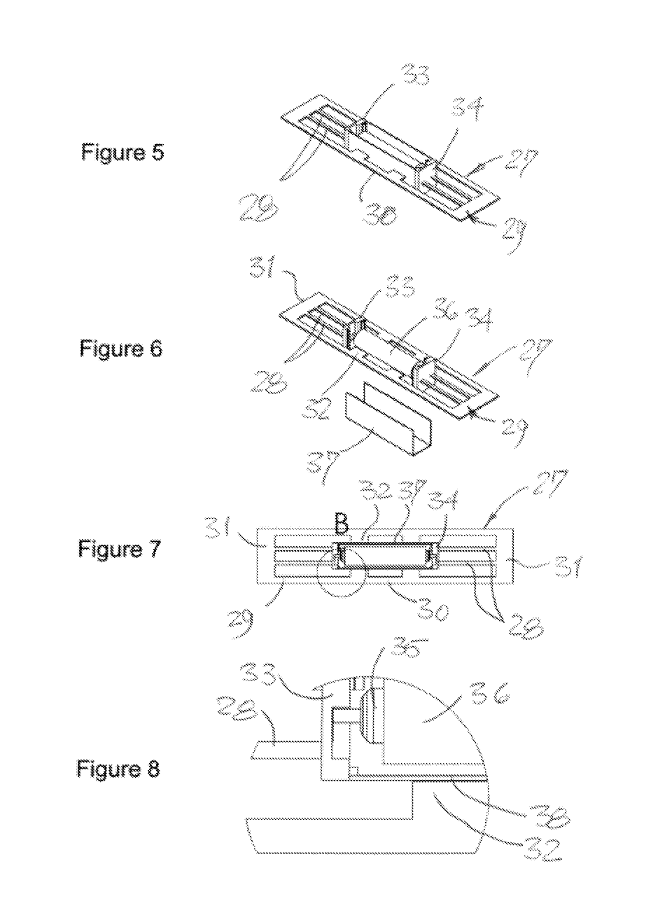

Referring now to FIGS. 3 to 8, there is shown an alternative reed relay manufacturing method, using the same principles as those described above with reference to FIGS. 1 and 2. Here, a single metal lead-frame 27 is provided with the various required conductors 28 and supporting parts 29 in a common plane, as best seen in FIGS. 5 and 7. The supporting parts include side strips 30 and end portions 31, each side strip including an inwardly projecting tab 32 for a purpose to be described below.

Two end plates 33,34 are insert-moulded to the lead-frame 27 such that the end plates are spaced-apart and parallel to one another, with the conductors 28 extending through the end plates at substantially 90° to the planes thereof. One or more rails or walls may be moulded integrally with the end plates to extend therebetween. The conductors 28 extend into the space between the end plates and may be turned through 90° for connection to the projecting pins from the two ends of a reed relay capsule 35 and also to a coil 36 surrounding the capsule. Alternatively, the conductors may be left co-planar, and the projecting pins from the reed relay capsule 35 connected directly thereto. A channel-shaped mu-metal shield 37 is fitted to the two end plates so as to surround on three sides the reed relay capsule 35 and coil 36. The shield is held in place by the tabs 32 of the lead-frame 27 and to assist this, the shield may have opposed grooves 38 formed along the two lower edges thereof, the tabs 32 being received in those grooves as best seen in FIG. 8.

The space defined by the two end plates 33,34 and the channel-shaped shield 37, within which are located the reed relay capsule and coil, is filled with a soft elastomeric material such as a silicon-rubber in order to encapsulate the relay. Here, the mu-metal shield 37 serves as an external housing for the relay and no other housing is provided, unlike the arrangement of FIGS. 1 and 2.

Following the encapsulation of the relay, the end portions 31 of the lead-frame are cut away so that the side strips also fall away from the relay, leaving just the two conductors 28 projecting from the end plates 33,34. The relay is finished by bending those conductors to the profile shown in FIG. 4, such that the free end portion of each conductor lies in a common plane substantially containing the lower face of the relay, as best seen in FIG. 4.

As with the previous embodiment, the manufacturing method may employ usual techniques and materials as is common with the manufacture of conventional reed relays. For example, the lead-frame may be manufactured from a Ni—Fe alloy plated with gold or tin. A high melting point solder may be used for connecting the relay capsule and coil to the conductors, internally of the relay so that those solder joints will not melt on soldering the device as a whole to a PCB. The end plates 33,34 may be moulded from a hard resin such as a thermo-setting material with a high melting point.

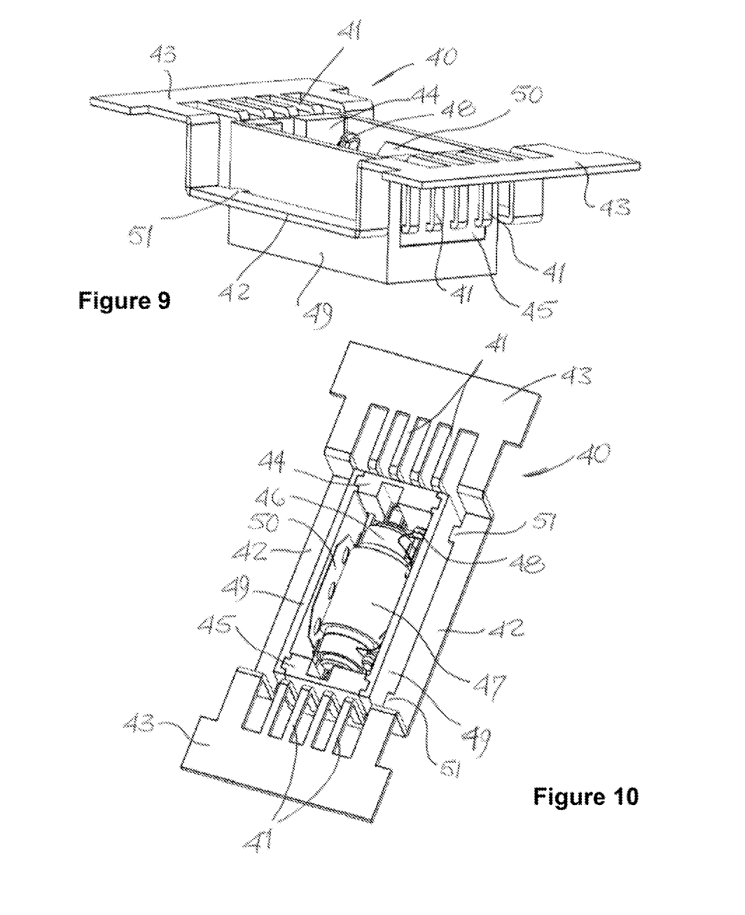

FIGS. 9 and 10 show a further embodiment of encapsulated SMD reed relay manufactured in accordance with the method of this invention, but before full encapsulation with a potting compound. In this embodiment, there is provided a single lead-frame 40 defining a plurality of conductors 41, side strips 42 and end parts 43. Initially, the lead-frame 40 is substantially planar and two plastics material end plates 44,45 are insert moulded to the conductors of the lead-frame such that the end plates are in a parallel, spaced apart disposition. Between the end plates, the conductors are then formed as required to allow the connection thereto of a reed relay capsule 46 and surrounding coil 47, by way soldered joints such as that shown at 48, the ends of the relay capsule being received in slots in the end plates. A plastics material housing 49 is separately moulded to have a U-shaped cross section and an internal magnetic metal screen 50 also of U-shaped cross section is fitted into the housing. The housing is then slid between the side strips 42 of the lead-frame to engage with the end plates 44,45 by way of tongue-and-groove connections, the housing being located by lugs 51 formed on the side strips 42. When assembled in this way, the components within the housing may be partially or even fully encapsulated by an appropriate potting compound (not shown). The external parts of the lead-frame are then bent through 90° adjacent the end plates 44,45 to lie parallel thereto and then bent again through 90° to lie in a common plane which also contains the upper (in the drawings) edges of the end plates 44,45 and the housing 49. Subsequently, the end parts 43 of the lead-frame are cut away, taking with them the side strips 42, and if not already fully encapsulated, the remaining space within the housing between the end plates is filled with the potting compound to the level of said common plane.

Though the description of this invention with reference to FIGS. 1 and 2 has referred to the use of a pair of relay capsules within a single coil of the relay, and with reference to FIGS. 3 to 8 and also FIGS. 9 and 10 to the use of only a single relay capsule, it will be appreciated that with all the arrangements a single or multiple relay capsules may be provided within a single coil in the relay housing. The number of connection pins required depends upon the number of capsules and so may differ from the numbers shown in the drawings. Further, the above description has referred to simple relay switches but other relays may be provided such as those with multiple contacts, change-over contacts and other known designs such as coaxial relays for use with coaxial cables.

1. A method of manufacturing a surface-mount encapsulated reed relay, comprising the steps of:
providing at least one metal lead-frame including conductors required for connecting the relay to a circuit, the conductors of the at least one lead-frame being mechanically interconnected by lead-frame parts;
insert-moulding a plastics material plate to the at least one lead-frame so that the conductors extend through the plate and are bonded thereto;
cutting away any unwanted lead-frame parts on at least one side of the plate, leaving the conductors exposed on said one side of the plate;
connecting a reed relay capsule and operating coil to the respective conductors on said one side of the plate;
fitting a housing to the plate so as to embrace the reed relay capsule and operating coil;
and then in either order:
injecting a soft elastomeric material into a space defined by the plate and the housing to encapsulate the relay capsule and the operating coil; and
cutting away any remaining unwanted lead-frame parts such that the conductors are exposed on the other side of the plate;
and thereafter:
forming said exposed conductors projecting from the other side of the plate to lie in a common plane substantially parallel to or co-planar with a face of the encapsulated reed relay which face will in use lie against a circuit board.

2. A method as claimed in claim 1, wherein the plastics material plate comprises a base plate for the encapsulated relay.

3. A method as claimed in claim 2, wherein the soft elastomeric material is injected into said space through an opening in the base plate.

4. A method as claimed in claim 2, wherein the conductors extend through the base plate at substantially 90° to the plane of the base plate and are turned through substantially 90° externally of the base plate.

5. A method as claimed in claim 1, wherein two metal lead-frames are provided and are arranged in a spaced-apart but substantially parallel disposition, and the insert-moulding step bonds the plastic material plate to the two lead-frames.

6. A method as claimed in claim 1, wherein the housing comprises a magnetic metal shield.

7. A method as claimed in claim 1 wherein a magnetic metal shield is fitted to the moulded plate and the housing overlies the shield with clearance therebetween.

8. A method as claimed in claim 6, wherein the magnetic metal shield is of a substantially U-shaped cross-section.

9. A method as claimed in claim 1, wherein the housing comprises a plastics material case fitted to the moulded plate.

10. A method as claimed in claim 1, wherein a single lead-frame is provided and two plastics material plates are insert-moulded to the conductors of the lead-frame so as to be bonded thereto, the two plates being moulded in a spaced-apart disposition whereby the reed relay capsule and operating coil are subsequently disposed between the two plates.

11. A method as claimed in claim 10, wherein the conductors extend through each of the plates at substantially 90° to the planes of the plates.

12. A method as claimed in claim 10, wherein the conductors are bent externally of the plates such that the free ends of the conductors are substantially co-planar and are in the plane of or parallel to a face of the manufactured relay.

13. A method as claimed in claim 10, wherein the single lead-frame provides all required relay conductors connected together by lead-frame parts and the subsequent cutting away of the lead-frame parts leaves each conductor isolated from the others.

14. A method as claimed in claim 10, wherein the housing is fitted to the two plates so as to embrace the reed relay capsule and operating coil disposed between said two plates.

15. A method as claimed in claim 14, wherein the housing comprises a magnetic metal shield.

16. A method as claimed in claim 14, wherein a magnetic metal shield is fitted to the spaced-apart plates and the housing overlies the metal shield.

17. A method as claimed in claim 15, wherein the metal shield is of a substantially U-shaped cross-section.

18. A method as claimed in claim 10, wherein the housing comprises a plastics material case extending between and engaged with the two spaced-apart moulded plates.

19. A method as claimed in claim 18, wherein a magnetic shield is fitted to the internal surfaces of the housing before the housing is engaged with the plates.

20. A surface-mount encapsulated reed relay whenever manufactured in accordance with a method as claimed in claim 1.

21. A surface-mount encapsulated reed relay comprising:
an insert-moulded plastics material plate having relay conductors extending therethrough and bonded to the plate;
a reed relay capsule and surrounding coil connected to respective conductors on one side of the plate;
a housing fitted to the plate so as to overlie the reed relay capsule and surrounding coil; and
a soft elastomeric material disposed within a space defined by the plate and housing to encapsulate the relay capsule and the coil;
wherein the conductors projecting from the side of the plate opposed to the capsule and coil are formed to lie in a common plane substantially parallel to or co-planar with a face of the encapsulated reed relay.

22. A surface-mount encapsulated reed relay comprising:
a pair of spaced-apart substantially parallel insert-moulded plastics material plates, each plate having relay conductors extending therethrough and bonded to the plate;
a reed relay capsule and surrounding coil connected to respective conductors between the two plates;
a housing fitted to the plates so as to overlie the reed relay capsule and surrounding coil;
a soft elastomeric material disposed within a space defined by the plates and housing to encapsulate the relay capsule and the coil;
wherein the conductors projecting from the sides of the plates opposed to the capsule and coil are formed to lie in a common plane substantially parallel to or co-planar with a face of the encapsulated reed relay.
